(19) United States
(12) Patent Application Publication
(10) Pub. No.: US 2008/0291022 A1
(43) Pub. Date: Nov. 27, 2008

(54) AUTOMATIC LOCATING SYSTEM

(76) Inventors: Erick Simon Amador, Miramar, FL (US); Christopher James Dawson, Arlington, VA (US); Barry Michael Graham, Silver Spring, MD (US); Rick Allen Hamilton, II, Charlottesville, VA (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/752,333

(22) Filed: May 23, 2007

(51) Int. Cl. G08B 13/14

(52) U.S. Cl. 340/572.1; 340/10.1

(57) ABSTRACT

In accordance with the present invention, radio frequency identification (RFID) and short message service center (SMS), or follow-on technology, e.g., Mobile Multimedia Services (MMS) technology is implemented to support an identification and messaging system. A social services server tracks a user's location with a RFID or GPS or similar system and also acquires locations for user-selected contacts which are made available to the system. When a system user is near a user-selected contact or individual within a selected group that the user wants to meet, a message or other alert, such as an SMS message, is automatically sent to the user's cellular telephone or other communications device, telling the user that the selected contact is nearby.

### FIELD OF THE INVENTION

The present invention relates generally to information processing systems and more particularly to a methodology and implementation for enabling user selection of an automatic locating system for a mobile social services system.

### BACKGROUND OF THE INVENTION

In the current art, no solution exists to quickly identify the location of known people within a local geographic area. Current systems require a “checking-in” process by which users are required to send messages to a server announcing where they are at any given time. Without the log-on process, that system does not track the user's current location or automatically track the user's location when it changes. For example, in shopping centers or theme parks there is no current automatic system which records current locations of selected individuals and automatically notifies a user when such selected individuals are within a user-selected distance from the user.

Thus, there is a need for an improved methodology and system for enabling improved processing of user and contact location information to facilitate notification to a user when the user is physically nearby pre-selected contacts.

### SUMMARY OF THE INVENTION

In accordance with the present invention, a social services server system automatically tracks a user's location using a tracking system, for example with a RFID or GPS or similar system, and also acquires locations for users and user-selected contacts and/or groups of contacts. In an exemplary embodiment, a social services server tracks a user's location with a RFID or GPS or similar system and also acquires locations for user-selected contacts which are made available to the system. When a system user is near a user-selected contact or individual belonging to a selected group of contacts that the user wants to meet, a message or other alert, such as an SMS message, is automatically sent to the user's cellular telephone or other communications device, telling the user that the selected contact is nearby. Users are also enabled to designate other time and circumstance conditions under which the user is willing to or desires to be notified of the proximity of the user to other designated contacts or individuals within designated contact groups.

### BRIEF DESCRIPTION OF THE DRAWINGS

A better understanding of the present invention can be obtained when the following detailed description of a preferred embodiment is considered in conjunction with the following drawings, in which:

FIG. 1 is a system diagram illustrating a system which may be used in an exemplary implementation of the present invention;

FIG. 2 is a schematic block diagram illustrating several of the major components of an exemplary computer system;

FIG. 3 is a schematic diagram illustrating an exemplary system for detecting user and contact locations within specific geographical areas;

FIG. 4 is an illustration showing a user interface for enabling a user to provide certain user selections relative to how the user wishes to use the location function of the present invention;

FIG. 5 is a flow chart illustrating an exemplary methodology for implementing a location function in association with the present invention; and

FIG. 6 is a flow chart illustrating an exemplary methodology for implementing a location function as it relates to other contacts trying to contact a user.

### DETAILED DESCRIPTION

It is noted that circuits, devices and flow charts which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

The various methods discussed herein may be implemented within any communication device capable of receiving and transmitting signals utilized in computer-based applications over any inter-connection network, including but not limited to the Internet and the World Wide Web. In the present disclosure such devices include, but are not limited to, cellular and other wireless devices and personal communications devices, and laptop and personal computers connected in local area or wide area networks.

The location detection and identification system described herein may be implemented by using any of the following technologies among others: GPS systems; Cellular Telephone Triangulation; any of several radio frequency identification systems; and/or user location detection using an IP network of mobile devices.

In an exemplary implementation, a user's location is automatically determined through any of the above techniques. For example, an RFID tag may be present in a cellular phone, conference ID Badge, theme park wrist band, or other personal item belonging to an individual. The disclosed method enables a transmission for the purpose of identifying a user's location and also a participant's present proximity to the user. Accordingly, RFID transceivers would be positioned throughout the participating environment (convention center, shopping mall, nightclubs, and so forth). The combination of transceiver and tag would allow a participant or user's presence and location to be detected and an alert to be triggered accordingly. Upon collection of a participant's location and verification with the registration system which may be maintained at a social services server for example, a message (including current position and the relative direction from the user to the located participant or contact would then be transmitted to the localized SMS messaging system for further transmission to the user or the person seeking the other participant. Upon receipt, the SMS or similar message (e.g. email) may be used to coordinate a desired meeting.

A significant function of the exemplary embodiment is the automatic or automated registration process of both the user and the other participants. Whether through pervasive RFID transceivers, or the other techniques described above, a participant's identification and location may be ascertained, thus enabling automated registration within a participant location's registry database, as well as verification of a participant's access permission (ensure that only willing contacts are identified and located by a user's contact or guest list.

Operable modes and scalable thresholds are also disclosed herein. With regard to operable modes of operation for social software services, it is noted that in today's art, the function is relatively binary. If a user decides that he wishes to be discoverable by friends, he allows himself to be contacted by them. However, this glosses over a level of nuance inherent in most people's behavior. In the disclosed embodiment, mobile social software services are segmented by groups, and furthermore those groups are either explicitly triggered (through manual entry on a web page or on a mobile device), or implicitly triggered (through reading of calendars, time of day, day of week, actual location, etcetera). For example, a user may have three groups defined in the user's “contact list”. Such groups may include, for example, coworkers; clubbing friends; and—parents and siblings. Consider furthermore that the user may then decide that he is reachable through SMS or analogous messages for meetings by “coworkers” only during the weekday; that he wishes to be reachable by “clubbing friends” at any time or day of the week; and by “parents and siblings” only during preset hours on weekends.

Through selective filtering and/or the geographic or chronological parameters set forth, the user is able to set up the system to provide this functionality. Further, with the present invention, a user may vary the conditions or thresholds under which the user may be contacted. The user is enabled to vary the thresholds for notification according to groups being considered, chronological information, or location information. For example, a user may stipulate that, if in a crowded conference hall, the user only wants to be notified if a targeted party or contact is within the same room. If that same user is on vacation in a distant city however, the user may stipulate by user input to the social services system that the user wants to know if either “clubbing friends” or “parents and siblings” are within forty miles. By the same token, the user may set the user's system so as to be “unreachable” to coworkers while on vacation. Through selective operators and selections made by a user, each of these enhancements can be made using the proposed system. In one example, a user having an RFID tag on their person, is automatically detected by an RFID transceiver located in a store within a shopping mall. The user's location is transmitted to a social services server data base and there is an automatic correlation between the user and any seekers who have expressed an interest in locating this user. Next, there is an automatic geographic correlation between both the user and the seeker and an automatic SMS text message is sent to the seeker about the user, and/or vice-versa.

In one embodiment, SMS text messages will only be sent when all four of the following conditions are true: a user/seeker has a detected contact in the user/seeker's “contacts” listing; the contact has a profile which states that the contact does not mind being located or contacted; the contact has the user/seeker in the contact's directory; and the contact is in the same geographic location as the user/seeker. When this scenario occurs, the system sends an SMS message to the user/seeker about the location of the contact. The system may also opt to send an SMS message to the contact also such that both parties are made aware of the request to meet. Thus, in the above example, both the user/seeker and the contact have stored profiles which limit location detection to a specific users. Further, the ability for a contact or to turn on and off the system such that they cannot be located, and to provide the gradients previously mentioned. Also, the disclosed system provides the ability to correlate located contacts and located users or seekers. The disclosed system also includes the ability to correlate both seeker and contact locations such that the system can identify when both are within the same geographic area. Also included is the notification method by which a seeker, and optionally a contact, is automatically alerted of the other's proximity. This alert may be in the form of an electronic signal such as an audio, visual or device vibration alert, either alone or in addition to an automatically generated text alert such as an SMS message. The following example shows the method that enables the solution. Again, the drawings illustrate a particularly technical design point (RFID), but the principles described can be extrapolated to any of the location determination methods described above (e.g., GPS, network IP address, etcetera).

The process begins with the RFID transceivers initiating a polling mode in which they can identify a user and their location. The participant's identity is then verified and registered with the tracking system. After registration, a check is performed to determine if other user, within the profile constraints (class of user, time, location) trying to locate this participant, or if there is another user in the general area which the identified person is trying to locate. If a desired user's profile matches the filtering constraints, this information is then transmitted to the tracking system's messaging system. This allows for the transmission of an SMS message which allows a meeting coordination.

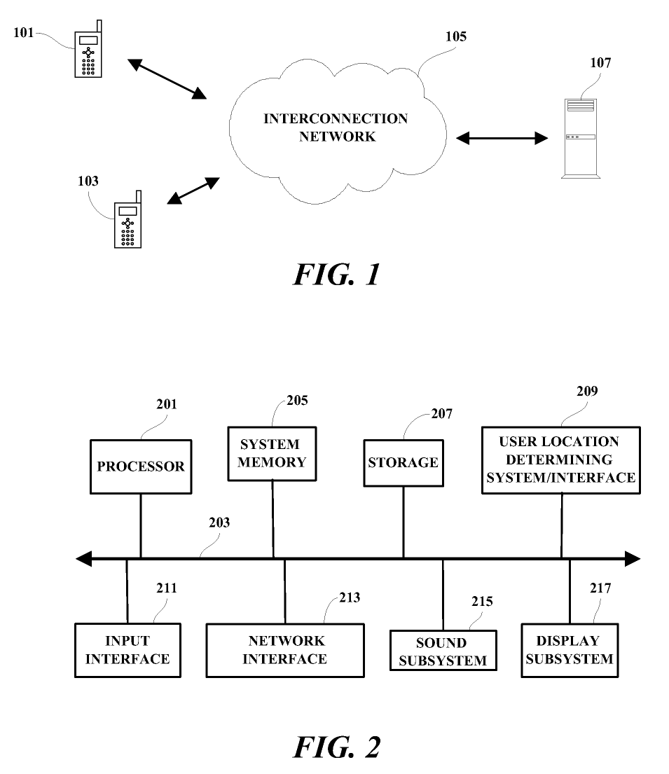

In FIG. 1, there is shown an exemplary system environment in which the present invention may be implemented. As shown, cell phones or other wireless communication devices 101 and 103 are arranged to be connected through an interconnection network 105, such as the Internet, to each other as well as to a social services server system 107. In FIG. 1, the devices 101 and 103 include a location-determining system such as a GPS unit by which the location of the device 101 or 103 can be determined at any given time and transmitted to the social services server 107. The function of the server 107 is to track and maintain a profile or data base of information and characteristics of participants in the auto-locating system as described above.

FIG. 2 illustrates several of the major components of the communication devices 101 and 103. As shown, a processor 201 is connected to a main bus 203. Also connected to the main bus is a system memory unit 205, a storage unit 207 and a user location determining system interface 209. As noted above, the user location determining system 209 may be any of many available systems including, but not limited to GPS systems, Cellular Telephone Triangulation, and/or any of several radio frequency identification systems as well as any user location detection system using an IP network of mobile devices. FIG. 2 also includes an input interface 211 connected to the bus 203 to enable user input to the system, for example, in making certain user selections with regard to the automatic participant locating system as is hereinafter described in greater detail. The input interface 211 may include for example, a keyboard or key pad and pointer device to enable user input through key actuation and or menu item selection from a display screen. A network interface 213, a sound system 215 and a display subsystem 217 are also connected to the main bus 203. Other subsystems not shown in FIG. 2 may also be connected to the main bus 203 as appropriate to particular applications.

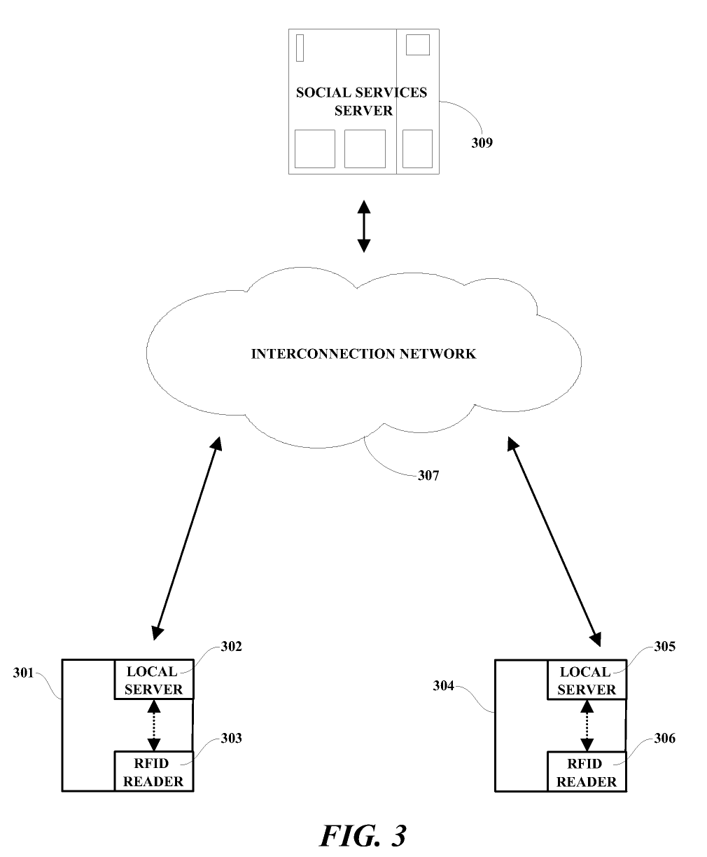

FIG. 3 illustrates a more detailed example in which RFID technology is implemented as the location determining system. As shown, locations 301 and 304 may be any two locations within a given geographical area. For example, locations 301 and 304 may be two outlet stores within an outlet shopping mall. Within each store, there is an RFID reader 303 and 305, respectively, and servers 302 and 305 associated with each RFID reader 303 and 306, respectively. The RFID servers 302 and 305 are operable to communicate through an interconnection network 307, such as the Internet, to a social services server 309. Generally, when a locating service participant wearing or carrying an RFID device is in the proximity of one of the readers 303 and 306, the identification information of the participant is transmitted from the participant's RFID device to the reader 303 or 306 and then from the RFID server 302 or 305 to the social services server 309. The server 309 maintains a data base for each participant and records the transmitted location and participant information for access to and use by other participants in the system.

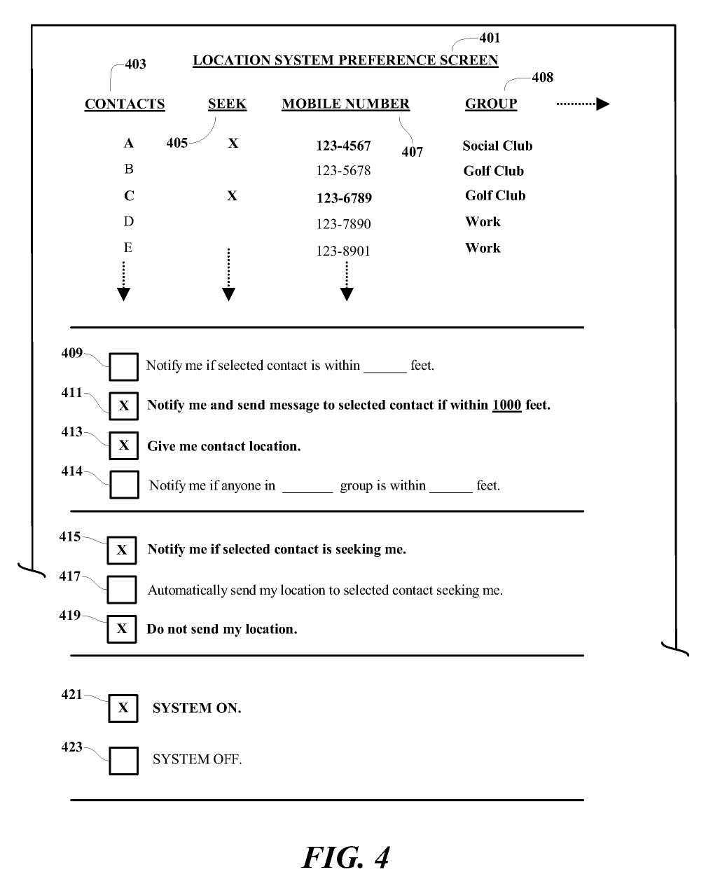

As shown in FIG. 4, each participant may selectively have displayed on his or her display, a Location System Preference Screen 401. The preference screen 401 enables a user or participant to input certain user preferences with regard to the automatic operation of the location detecting system. The social services data base includes contact information of the user and his or her personal friends or associates as well as the user's personal preferences with regard to finding other participants and having other participants find the user. The data base may be maintained at a social services server or within the user's communication device and kept updated with participant location information by selective transmissions from the user's social services server.

The location system preference screen includes the names of the user's contacts 403, a selection space 405 or other means to enable a user to indicate which of the contacts the user wishes to seek, the mobile or wireless number 407 of the contacts 403, and a group designation 408, for example “Social Club”, “Golf club” or “Work”, for each of the contacts 403. In another section of the screen 401, a user is enabled to select certain actions that the user wishes to take with regard to the selected individuals when the locating system determines that one of the selected individuals 405 is in the proximity of the user or seeker. In the exemplary selection screen 401, a user may initially select certain individuals with whom the user wishes to meet if it is determined that the selected individuals are in proximity to the user or seeker. Such actions include, for example, to notify the user if the selected individual 405 is within a selected distance from the user 409, or to notify and send a message to the selected individual 411, and/or to give or display the location information of the selected individual 413, and/or to notify the user or seeker if anyone from a selected group is within a selected distance from the user 414. In another section, the user may select certain other conditions with regard to when it is detected by the system that another participant is seeking the user. For example, the user is enabled to indicate that the user wishes to be notified when someone else is seeking the user 415, and/or to automatically send the user's location to anyone seeking the user 417 and/or not to send the user's location to anyone 419. Although not shown in the drawing, designated times of contact may also be input by the user such that the selected notifications will only be provided to the user during the times when it would be convenient as selected by the user. The selections input by the user may be entered and the system turned ON 421 as the user is leaving for a meal in a restaurant. Thereafter, if anyone of the selected individuals 405 is detected as being within the designated distance of the user 411, a message may be sent to the detected individual being sought 411 and the location of the detected individual may be displayed to the user 413 while the user has the system turned ON 421. Optionally, the user may turn the system OFF 423 and not actively participate in the locating system until the user again activates the locating system through the user's communication device 101, 103.

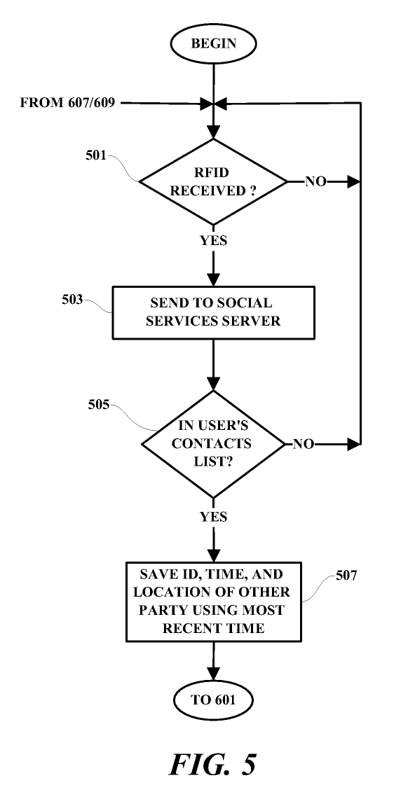

An exemplary operation of the system is shown in flow chart form beginning with FIG. 5. As shown, when an RFID information is received 501 from a participant, that information (generally the ID and location of the detected individual) is transmitted to the social services server 503. If the detected individual is in the user's contacts list 505, the ID, time and location of the detected individual is saved to memory 507 for future reference and access by the system.

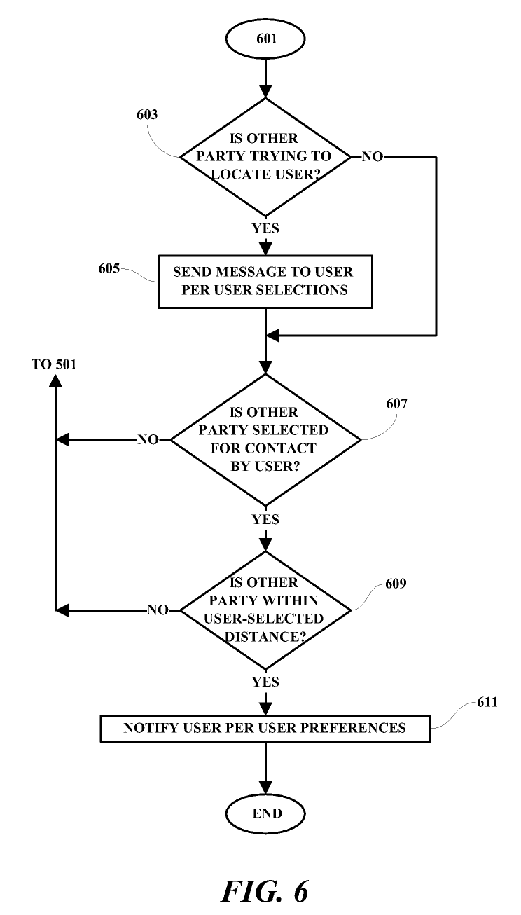

As shown in FIG. 6, if another party is trying to locate the user 603, a message may be sent to the user 605 if the selected criteria are met. If the other party is selected for contact by the user 607, then if the other party is within the selected distance from the user 609 and the other user selected criteria are met, the user and the other party are notified per the preferences 611 selected by the parties.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical or magnetic memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling a user to initiate an automatic determination of a location of a selected individual relative to a location of said user, said method comprising:
enabling an automatic determining of a location of said user;
enabling an automatic determining of a location of said selected individual; and
notifying said user when said selected individual is within a predetermined distance from said user.

2. The method as set forth in claim 1 wherein said selected individual is selected by said user from a listing of individuals displayed on a user device.

3. The method as set forth in claim 1 wherein said location of said user and said location of said selected individual are determined by processing location information received from devices carried by said user and said selected individual, respectively.

4. The method as set forth in claim 3 wherein at least one of said devices is a radio frequency identification (RFID) device.

5. The method as set forth in claim 4 and further including:
transmitting information identifying said selected user from one or more RFID reader devices, said reader devices being located at known locations.

6. The method as set forth in claim 3 wherein at least one of said devices is a wireless communication device, said wireless communication device including a global positioning system (GPS) device.

7. The method as set forth in claim 1 wherein said user is enabled to selectively change said predetermined distance.

8. The method as set forth in claim 1 wherein said notifying is accomplished by sending an electronically generated perceptible notification to said user.

9. The method as set forth in claim 1 wherein said notifying is accomplished by sending an electronically generated text notification to said user.

10. The method as set forth in claim 1 wherein said user is enabled to selectively input predetermined time periods when said automatic determination is accomplished.

11. The method as set forth in claim 1 wherein said user is enabled to selectively designate one or more groups associated with each individual on said listing, said user being further enabled to initiate said automatic determination of a location by designating one or more of said groups.

12. A system for enabling a first device to initiate an automatic determination of a location of a second device relative to a location of said first device, said system comprising:
a first device operable for automatically providing first information signals determinative of a location of said first device;
a second device operable for automatically providing second information signals determinative of a location of said second device; and
processing means arranged for processing said first and second information signals and providing an alert signal to said first device when said second device is within a predetermined distance of said first device.

13. The system as set forth in claim 12 wherein at least one of said first or second devices is a radio frequency identification (RFID) device.

14. The system as set forth in claim 13 and further including:
means for transmitting information identifying one of said first or second devices from one or more RFID reader devices, said reader devices being located at known locations.

15. The system as set forth in claim 12 wherein at least one of said first or second devices is a wireless communication device, said wireless communication device including a global positioning system (GPS) device.

16. The system as set forth in claim 12 and further including means for enabling a user to selectively change said predetermined distance.

17. The system as set forth in claim 12 wherein said providing said alert signal is accomplished by sending an electronically generated perceptible notification to said first device.

18. The system as set forth in claim 12 wherein said providing said alert signal is accomplished by sending an electronically generated text notification to said first device.

19. A programmed medium, said programmed medium being selectively coupled to processing circuitry, said programmed medium containing indicia readable by said processing circuitry for providing program signals effective for enabling a first device to initiate an automatic determination of a location of a second device relative to a location of said first device, said program signals being further operable for:
enabling an automatic determining of a location of said first device;
enabling an automatic determining of a location of said second device; and
providing an alert signal to said first device when said second device is within a predetermined distance of said first device.

20. The programmed medium as set forth in claim 19 wherein said program signals are further operable for:
displaying a listing of devices associated with identified individuals; and
enabling a user of said first device to select one or more devices from said listing for automatic determination of locations of said selected one or more devices.
